(19) United States
(12) Patent Application Publication
(10) Pub. No.: US 2011/0006636 A1
(43) Pub. Date: Jan. 13, 2011

(54) DC MACHINE

(76) Inventors: Jae Yong Shin, Daejeon-shi (KR); Frank Kopf, Ottersweier (DE); Oliver Scheib, Schweigen-Rechtenbach (DE); Markus Liedel, Pegnitz (DE); Michael Kupferer, Rheinau Freistett (DE); Michael Strupp, Durmersheim (DE)

Correspondence Address: KENYON & KENYON LLP, ONE BROADWAY, NEW YORK, NY, 10004, US

(21) Appl. No.: 12/744,440

(22) PCT Filed: Sep. 23, 2008
(86) PCT No.: PCT/EP08/62651

§ 371 Date: Sep. 16, 2010

(30) Foreign Application Priority Data
Nov. 22, 2007 (DE) 10 2007 056 323.1

(51) Int. Cl. H01R 39/40; H01R 39/38; H02K 11/02

(52) U.S. Cl. 310/247; 310/239; 310/72

(57) ABSTRACT

A DC machine, particularly a DC motor for use in a motor vehicle, includes a stator, a rotor that is supported rotatably in a pole housing having a commutator, and having a brush-holder support, made substantially of plastic, for fixing at least two brushes and further components. The brush-holder support has a device for improving the positioning of the components situated on or at it relative to the rest of the machine and/or for shortening the tolerance chain of the machine, in particular, a longtime stabilization of the overall equipment being also achieved.

### FIELD OF THE INVENTION

The present invention relates to a DC machine, particularly for a DC motor for use in a motor vehicle.

### BACKGROUND INFORMATION

Such brush-commutated DC machines having a plastic brush-holder support are basically known, for instance, from DE 38 18 891. This document shows a DC machine having a disk-shaped brush-holder support designated there as a base, which is entirely made of plastic and is connected rigidly, in a predefined position with respect to the commutator of the machine, to its pole housing. As to the positioning of components on the brush-holder support of the machine, the document only makes statements with regard to the connection of the brushes, which are electrically connected and fastened to the connecting lines of the machine in a contact piece.

### SUMMARY

Example embodiments of the present invention provide that the tolerance chain of a DC machine, conditioned upon the production and the assembling of the brush-holder support, is clearly reduced. This particularly achieves that the brush-holder support of the machine has sufficient stability in itself, as well as defined fastening and positioning possibilities for the components that are to be situated on it, and at the same time is designed so that its production is able to be automated without difficulties.

An especially great stability of the brush-holder support is achieved by having its base plate strengthened or stiffened by dome-like structures, whereby a plurality of interconnected planes is created, which clearly increases the bending strength and the resistance to torsion of the brush-holder support, and with that, the positioning accuracy of the components situated on it.

For the largely voltage-free fastening of the brush-holder support on the pole housing, it is advantageous if the former has a mounting flange on its circumference which is preferably only connected pointwise to the base plate of the brush-holder support. The mounting flange is fitted in between the pole housing and the adjacent bearing cover, and the brush-holder support is thereby largely decoupled from the metal housing of the machine, whereby, on the one hand, different heat expansions may individually develop at the pole housing and at the brush-holder support, without the plastic brush-holder support being deformed. On the other hand, this design additionally yields noise decoupling between the brush-holder support and the housing, since vibrations on the brush-holder support are transferred to the housing, to only a slight degree.

Another advantageous design possibility for the brush-holder support, with regard to simplifying assembly and to the reliable fastening of the contact springs for the brushes, is yielded if the brushes are locked on the commutator-side end of the brush cartridge, using a Z-shaped end section.

Such a design of the spring end, on the one hand, ensures the independent alignment of the spring when it is mounted on the brush cartridge, and on the other hand, the Z-shape ensures reliable locking in operation. The locking and adjustment of the brush press-on spring may even be additionally improved, in this instance, if the Z-shaped end section of the press-on spring has an opening for the passage of a positioning pin at the brush cartridge. In this way the press-on spring is held with point accuracy.

Besides the brushes themselves, particularly interference suppressors, such as chokes and capacitors are situated on the brush-holder support. For the durable, shake-proof fastening of at least one interference suppressing capacitor it is expedient, in this instance, if the latter is situated in a mounting support that is extruded of plastic in one piece with the brush-holder support and that is aligned perpendicular to the machine axis, which is preferably developed as a box type. The interference suppressor capacitor is thus reliably held on all sides, its terminal lugs remaining freely accessible and being able to be connected simply and reliably to the outer electrical connecting leads of the machine.

When metallic brush cartridges are used, it is for the expedient aim of an especially great firmness and shake-proof stability if, at the assembly cutouts on the underside of the base plate of the brush-holder support, in the area of the passage of little crimpable cartridge feet, bend-over ribs for the latter are situated. This ensures an especially firm seat of the brush-holder support during the crimping of the little cartridge feet.

Further details and aspects of example embodiments of the present invention are described in more detail below.

### BRIEF DESCRIPTION OF THE DRAWINGS

FIG. 1 is a sectional view of the DC machine arranged according to an example embodiment of the present invention.

FIG. 2 is a perspective partial view of the brush-holder support in the area of the connection of the interference suppressor components fastened on it.

FIG. 3 is a perspective overall view of the unassembled brush-holder support.

FIG. 4 is a perspective partial view of the brush-holder support in the area of the brush cartridges.

FIG. 5 is a top view of a brush-holder support assembled with brushes and interference suppressor components.

FIG. 6 is a perspective partial view of the brush-holder support having a brush press-on spring.

### DETAILED DESCRIPTION

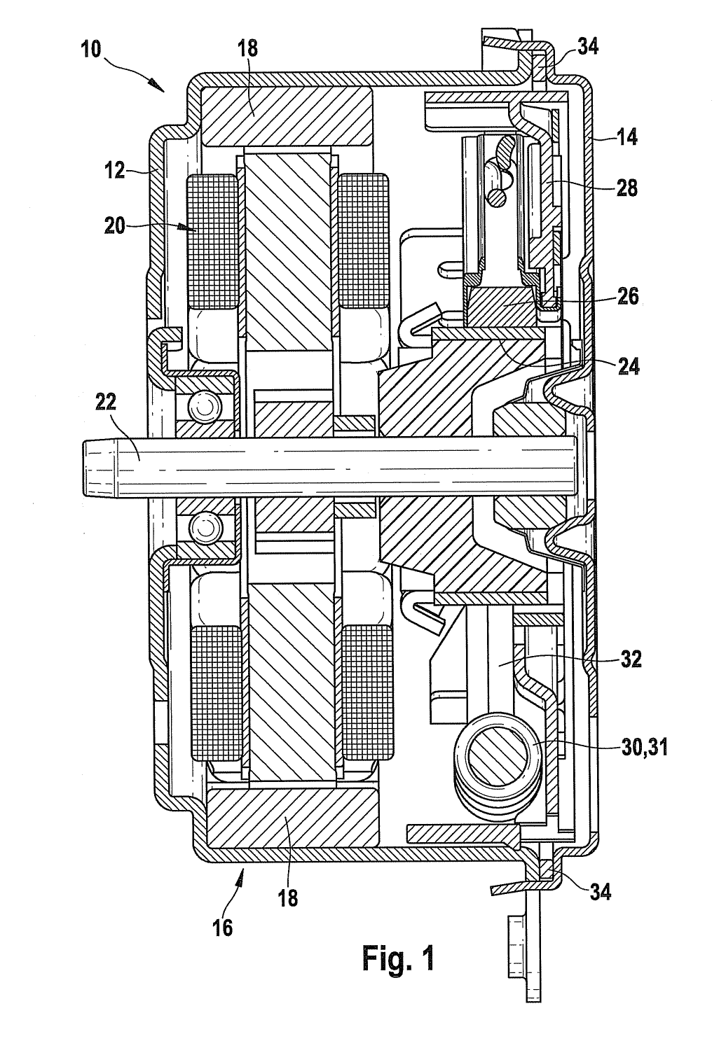

FIG. 1 shows a DC machine 10 executed as a DC motor for use in a motor vehicle. The machine has a pot-shaped pole housing 12, which is closed on one side by a bearing cover 14. Inside pole housing 12, a stator 16 is developed by permanent magnets 18, which are fastened to pole housing 12 in a known manner. A rotor 20 of the machine is positioned on a shaft 22, which is rotatably supported, on one side in pole housing 12, and on the other side in bearing cover 14. Furthermore, there is a commutator 24 situated on rotor shaft 22, to which the field current for rotor 20 is supplied via brushes 26.

Brushes 26 and additional components, especially the required interference suppressor of the machine, are held on a brush-holder support 28. Of the interference suppressor of the motor, one may see in FIG. 1 an interference suppression choke 30 and a capacitor 32. The locking of brush-holder support 28 in pole housing 12 takes place by a mounting flange 34, which extends over the entire circumference of the brush-holder support and is clamped in between pole housing 12 and bearing cover 14 in the finished assembled state of the machine. The design and the assembling of brush-holder support 28 are explained in detail with the aid of the following figures, in which the same reference numerals are used for the same parts.

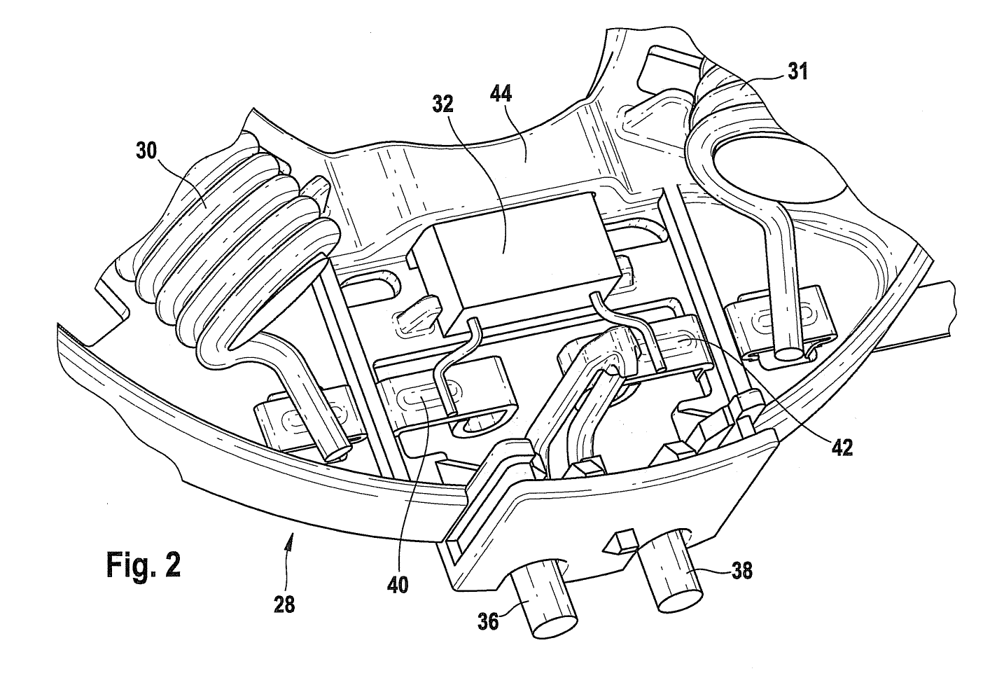

FIG. 2 shows a perspective representation of a part of brush-holder support 28 that is made of extruded plastic. The current supply of a DC voltage source (not shown) takes place via two connecting lines 36 and 38, which are connected on one side to the positive pole, and on the other side to the negative pole of the DC voltage source (not shown), as well as via contact pieces 40 and 42 to interference suppression reactors 30 and 31. At the same time, connecting line 36 is connected to one electrode and connecting line 38 is connected to the other electrode of interference suppression capacitor 32. The latter is locked durably and in a shake-proof manner in a mount developed as a pocket 44, that is aligned perpendicular to the machine axis. Pocket 44 is extruded in one part with brush-holder support 28 from plastic, in this instance. Instead of a pocket-shaped arrangement, the mount could however also be executed in the form of a retention arm or in the form of a retaining hoop, it being essential that the alignment of the mount is perpendicular to the machine axis, in order to ensure a durable, shake-proof locking of capacitor 32.

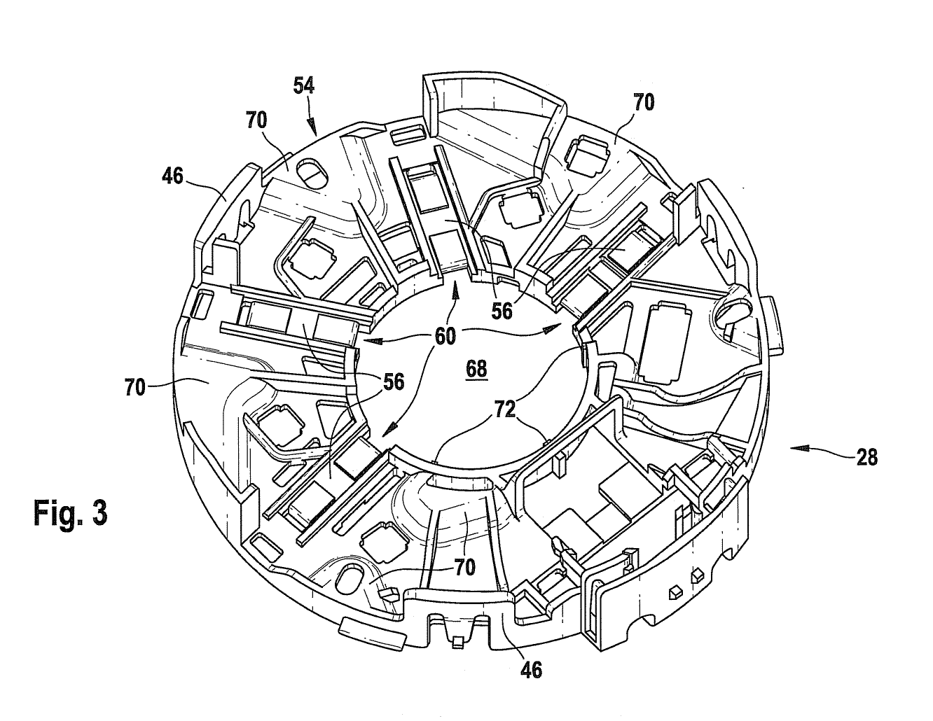

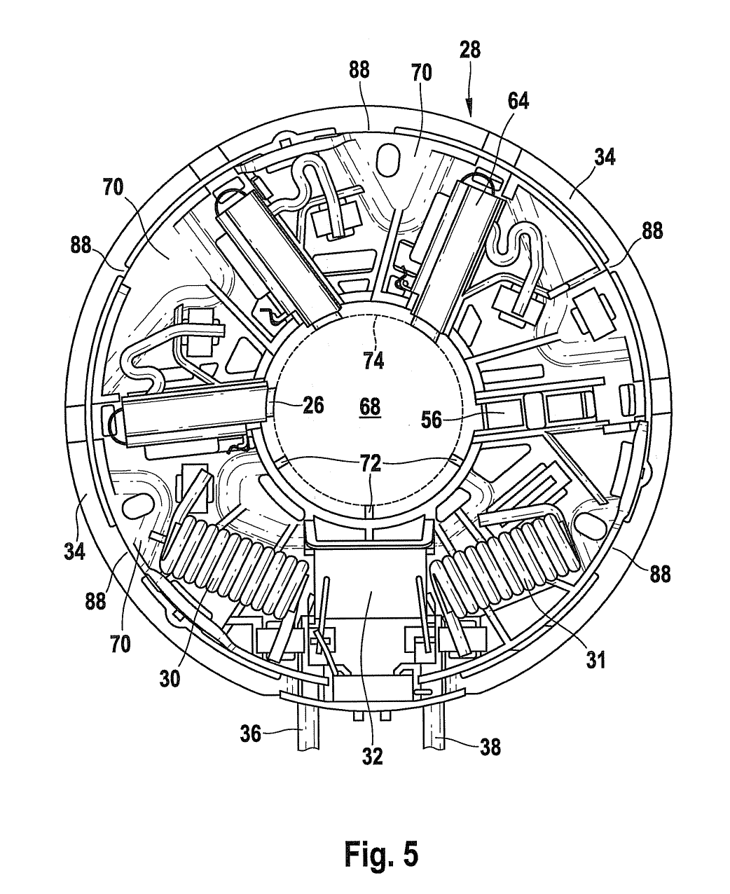

FIG. 3 shows a perspective view of the non-assembled brush-holder support 28. Besides the arrangements already discussed, its base plate 54 has a plurality of assembly recesses 56 for mounting a variable number of brush cartridges that are not shown in this figure. Brush-holder support 28 according to FIG. 5 has four assembly recesses 56 of which, depending on the design of the DC machine, optionally two, three or four may be assembled with brush-holder supports 28 in a known manner.

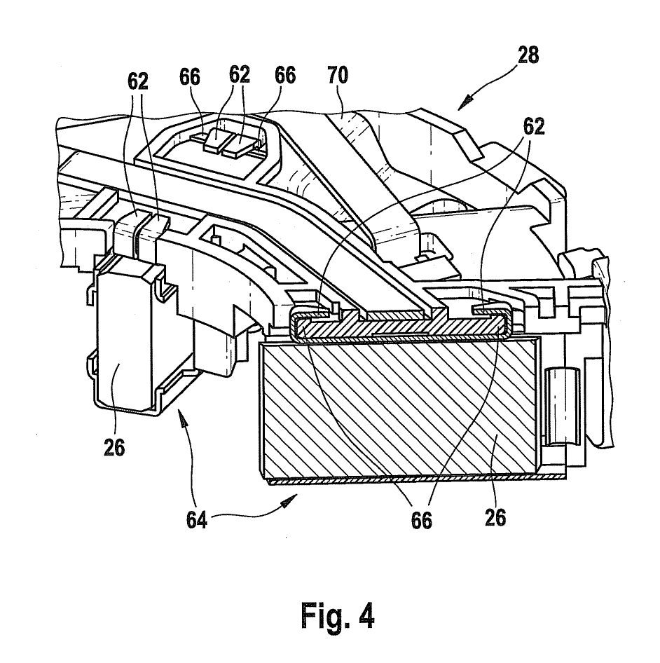

The brush cartridges, metallic as a rule, that are not shown in FIG. 3, are secured using little cartridge feet, which on one side reach through cutouts 58 in base plate 54 of the brush-holder support and around inner end 60 of assembly cutouts 56, and are crimped below base plate 54, as may be seen in FIG. 4. At the lower side of base plate 54 of brush-holder support 28 that is visible in FIG. 4, in the area of the passage of the little cartridge feet 62 of brush cartridges 64, in this case bend-over ribs 66 are formed on base plate 54 which, upon the crimping of little cartridge feet 62, ensure a durable seat of brush-holder supports 28 that is free of play. The central opening for the later passage of commutator 24 through brush-holder support 28 is marked 68. Moreover, in FIGS. 3 and 4, dome-like structures 70 will be seen on base plate 54 of brush-holder support 28, which clearly increase the bending strength of the base plate. In that manner base plate 54 is able to be shaped and stiffened in several planes.

FIG. 5 shows a top view of a brush-holder support 28 assembled with brushes 26 and interference suppression components 30, 31 and 32, in which one may see the distribution of the assembly components on the brush-holder support. The illustration shows that assembly cutouts 56 for brush-holder supports 28 are situated on base plate 54 such that the brushes are located in a first sector that extends approximately over the upper half of the base plate and the electrical interference suppression means 30, 31, 32 are located in a second sector on the lower half of base plate 54. By this arrangement it is achieved that interference suppressed electrical connections to chokes 30 and 31 and to capacitor 32 run outside the outer sector of brush-holder support 28 taken up by brushes 26, and thus no interference signals are induced any more in the electrical connections of the brushes that have already been interference suppressed, whereby the electromagnetic compatibility (EMC) of the machine is clearly improved.

In the lower range of central opening 68 in brush-holder support 28, three centering ribs 72 may be seen, which extend for approximately the same distance into central opening 68 of brush-holder support 28 as brushes 26 themselves, at their contacting rest on commutator 24, that is not shown in FIG. 5. This arrangement is indicated by a circular dotted line 74. In this way, the centering of an assembly aid, that essentially corresponds to dotted line 74 in its design for fitting commutator 24 into central opening 68 in brush-holder support 28, is clearly simplified. For reasons of symmetry, in this context, centering ribs 72 are distributed uniformly over the lower sector of brush-holder support 28, that is not occupied by brushes 26.

Furthermore, in FIG. 5 the design of mounting flange 34 for brush-holder support 28 is also shown, which extends over the entire circumference of brush-holder support 28, but which is connected only pointwise to it via a plurality of crosspieces 88 that are distributed along the circumference. Mounting flange 34 and crosspieces 88 are extruded of plastic in one part with brush-holder support 28. In order to lock brush-holder support 28, flange 34 is firmly clamped between the edge of pole housing 12 and the opposite edge of bearing cover 14, whereby a reliable holding and an exact axial positioning of brush-holder support 28 are ensured. At the same time, however, because of the pointwise connection of brush-holder support 28 to mounting flange 34, the brush-holder support element is largely decoupled from pole housing 12, so that different thermal expansions of brush-holder support 28 and pole housing 12 are able to develop individually, without base plate 54 of brush-holder support 28 becoming domed. In addition, noise decoupling is created between brush-holder support 28 and pole housing 12, bringing on a clear reduction in the noises eradiated by the machine.

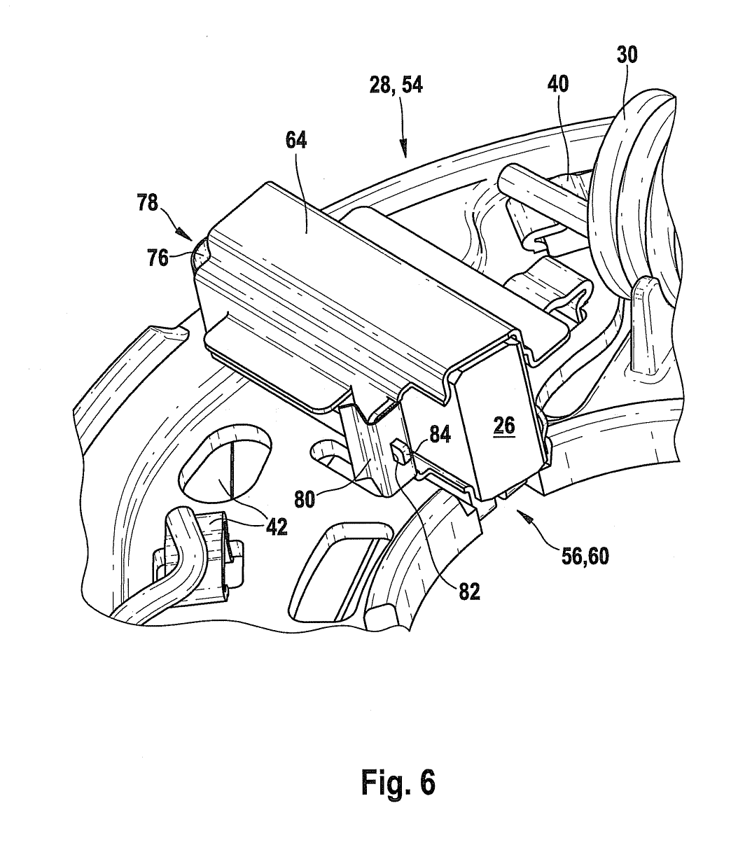

FIG. 6 shows a perspective partial view of brush-holder support 28 in the vicinity of a brush 26, from which one is able to see the arrangement of a spring 76 arranged as a coil spring, for pressing brush 26 against commutator 24. With its rolled end 78, the spring extends into brush cartridge 64 and presses brush 26 in the direction towards the commutator, and using its Z-shaped end section that faces commutator 24, it embraces brush cartridge 64 and is locked on it at rest. In addition, Z-shaped end section 80 of spring 76 has an opening 82 for the passage of a positioning pin 84 on brush cartridge 64, whereby spring 76 is held and positioned, with point accuracy and in a shake-proof manner, on brush cartridge 64.

1-10. (canceled)

11. A DC machine, comprising:
a stator;
a rotor supported rotatably in a pole housing having a commutator; and
a brush-holder support, made substantially of plastic, adapted to hold at least two brushes and further components;
wherein the brush-holder support includes a device adapted to at least one of (a) improve positioning of the components relative to the rest of the machine and (b) shorten a tolerance chain of the machine.

12. The DC machine according to claim 11, wherein the DC machine is arranged as a DC motor for use in a motor vehicle.

13. The DC machine according to claim 11, wherein a base plate of the brush-holder support is strengthened by dome-shaped structures.

14. The DC machine according to claim 11, wherein the brush-holder support has a mounting flange on its circumference which, after assembly of the machine, is locked on the pole housing between edge of the pole housing and a bearing cover.

15. The DC machine according to claim 14, wherein the mounting flange is connected pointwise to the rest of the brush-holder support.

16. The DC machine according to claim 14, wherein the mounting flange is annular and is connected to the base plate of the brush-holder support by symmetrically situated crosspieces.

17. The DC machine according to claim 11, wherein a spring adapted to press a brush against the commutator is locked by a Z-shaped end section at a commutator-side end of the brush cartridge.

18. The DC machine according to claim 17, wherein the Z-shaped end section of the press-on spring has an opening adapted for passage of a positioning pin on the brush cartridge.

19. The DC machine according to claim 11, wherein at least one interference suppression capacitor is positioned and fastened on the brush-holder support by a mounting support having its large surfaces in an alignment perpendicular to a machine axis.

20. The DC machine according to claim 19, wherein the mounting support for the interference suppression capacitor is pocket-shaped.

21. The DC machine according to claim 11, wherein, on an underside of the brush-holder support in an area of assembly cutouts for crimpable little cartridge feet of the brush cartridges, bend-over ribs for the little cartridge feet are situated.
